(19) United States
(12) Patent Application Publication
(10) Pub. No.: US 2026/0127144 A1
(43) Pub. Date: May 7, 2026

(54) HYBRID DATA STORAGE ARCHITECTURE FOR MULTI-TENANT SERVICES

(71) Applicant: SAP SE, Walldorf (DE)

(72) Inventor: Hui Li, Shanghai (CN)

(21) Appl. No.: 18/937,594

(22) Filed: Nov. 5, 2024

(51) Int. Cl. G06F 16/21; G06F 16/242; G06F 16/25

(52) U.S. Cl. CPC G06F 16/211; G06F 16/2445; G06F 16/258

(57) ABSTRACT

Systems and methods described herein relate to a hybrid data storage architecture for multi-tenant services. A first tenant selects a standalone schema and a second tenant selects a shared schema. The standalone schema is generated for the first tenant. First data of the first tenant is stored in a plurality of dedicated tables of the standalone schema. Second data of the second tenant is stored in a plurality of shared tables of the shared schema. A virtual schema comprises view definitions that correspond to the plurality of shared tables and that filter based on a tenant identifier of the second tenant. The second data is operated on via the virtual schema. One or more data operations with uniform operation patterns are applied across the standalone schema and the shared schema.

### TECHNICAL FIELD

The subject matter disclosed herein generally relates to cloud computing technologies. More specifically, but not exclusively, the subject matter relates to a hybrid data storage architecture for multi-tenant services or platforms, such as software as a service (SaaS) platforms.

### BACKGROUND

In a multi-tenant system (e.g., a SaaS platform), a single database or database system serves multiple tenants. To manage database storage, the multi-tenant system typically utilizes either a standalone schema data storage model or a shared schema data storage model. In the standalone schema model, each tenant owns a respective standalone schema with dedicated tables, and the standalone schemas typically utilize the same database table structure. In the shared schema model, tenants share a common database schema, with data coexisting in common tables and different tenants being distinguished by way of tenant identifiers.

A standalone schema model can provide technical benefits such as stricter segregation of data, better data security, and easier data migration or recovery. However, as the number of tenants grows, the database has to maintain an increasing number of tables, consuming significant hardware and software resources and potentially degrading system performance. A shared schema model consumes comparatively less resources per tenant, often making the shared schema model a less costly option. However, the shared schema model can introduce technical complexities in ensuring proper data segregation, maintaining data security, or facilitating data migration or recovery.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes a database schema management system to implement a hybrid data storage architecture, according to some examples.

FIG. 2 is a block diagram of components of a database schema management system, according to some examples.

FIG. 3 is a diagrammatic representation of a hybrid data storage architecture, according to some examples.

FIG. 4 is a flowchart illustrating operations of a method for providing hybrid data storage in a multi-tenant environment, according to some examples.

FIG. 5 is a flowchart illustrating operations of a method for automatically converting a schema type from a standalone schema to a shared schema, according to some examples.

FIG. 6 is a flowchart illustrating operations of a method for automatically converting a schema type from a shared schema to a standalone schema, according to some examples.

FIG. 7 is a user interface diagram illustrating a user interface that enables the selection of a standalone schema or a shared schema, according to some examples.

FIG. 8 is a user interface diagram illustrating a user interface that enables the triggering of a conversion request for changing a schema type, according to some examples.

FIG. 9 is a block diagram showing a software architecture for a computing device, according to some examples.

FIG. 10 is a block diagram of a machine in the form of a computer system, according to some examples, within which instructions may be executed for causing the machine to perform any one or more of the methodologies discussed herein.

### DETAILED DESCRIPTION

Systems and methods described herein relate to a hybrid data storage architecture.

Examples in the present disclosure provide a flexible, adaptable system that incorporates multiple storage models to cater to diverse tenant requirements. For example, tenants are provided with different storage model options within the context of a single SaaS platform.

While existing multi-tenant systems require tenants to adhere to a single storage model (e.g., the model chosen by the SaaS provider), the present disclosure provides a technical solution that enables tenants to choose between a standalone schema and a shared schema based on their specific requirements or preferences. This approach provides flexibility by offering technical benefits of both storage models.

Examples in the present disclosure provide a consistent interface for at least some data operations across both standalone and shared schemas, enabling the system to maintain uniform operation patterns for operations such as querying, editing, and deleting data, regardless of the underlying schema type chosen by each tenant. Additionally, the system may provide a mechanism for automatically converting between schema types.

A “standalone schema,” as used herein, refers to a dedicated schema for an individual entity, such as a tenant, account, or user (e.g., an individual database schema for a specific tenant in a multi-tenant system). A standalone schema may include a plurality of dedicated tables that store data exclusively for a single tenant. For example, a standalone schema named “SCHEMA_1” may be created for “TENANT_1,” containing dedicated tables such as “PRODUCTION” and “ORDERS,” where each table stores data specific to “TENANT_1” without information from other tenants.

A “shared schema,” as used herein, refers to a common schema that stores data for multiple entities, such as different tenants, accounts, or users (e.g., a shared database schema that stores data for multiple tenants in a multi-tenant system). A shared schema may include a plurality of shared tables that contain data from multiple tenants, distinguished by a tenant identifier. For example, a shared schema named “SCHEMA_SHARED” may contain a table called “PRODUCTION,” which includes a column “TENANT_ID” to differentiate data belonging to different tenants.

A “virtual schema,” as used herein, refers to a schema (which may be virtual or logical) that defines or identifies views, virtual tables, or similar features to enable a system to provide a tenant-specific view of data stored in a shared schema. For example, a virtual schema is generated for a tenant that opts for a shared schema. The virtual schema provides one or more views that filter data based on the tenant identifier of that tenant. Thus, in some examples, while the standalone and shared schemas store actual tables with underlying data, the virtual schema is referred to as “virtual” because it stores view definitions or similar data, instead of storing underlying data (e.g., real tables). For example, if a shared schema “SCHEMA_SHARED” contains a table “PRODUCTION” with data from multiple tenants, a virtual schema “SCHEMA_2” for “TENANT_2” may define a view named “PRODUCTION” that selects only the rows where “TENANT_ID” matches the tenant identifier of “TENANT_2.” In some examples, a virtual schema can be dynamically and automatically changed to a standalone schema, and vice versa.

Examples in the present disclosure provide various technical solutions to technical problems. The rigid approach of configuring a system according to either a standalone schema model or a shared schema model creates technical challenges in meeting diverse tenant requirements within a single system. For instance, some tenants might require strict data isolation and dedicated resources, while others prioritize cost-efficiency over data isolation. The inability to accommodate both preferences within the same system may lead to inefficient resource allocation or potential security concerns. The subject matter described herein addresses or alleviates technical challenges by providing a hybrid storage model that allows tenants to choose between standalone and shared schemas within the same system.

For tenants who opt for the shared schema, their data is stored in a common schema. This may significantly reduce the number of tables and overall database stress compared to a purely standalone model. The use of views in virtual schemas for shared tenants further minimizes data duplication and storage requirements. This approach enables the system to support a large number of tenants with fewer hardware and software resources, particularly benefiting from the scalability of the shared schema model. Additionally, the ability to convert between storage models allows for dynamic resource optimization as tenant needs change over time, further enhancing the system's efficiency in resource utilization.

While enabling support for multiple schema types is beneficial, inconsistent data operation patterns can lead to increased complexity in application development and maintenance. For example, SQL query structures across different schemas can vary significantly. The lack of a unified approach to data operations across schema types may increase the risk of errors, increase development time, or create difficulties in system maintenance and upgrades. Examples in the present disclosure alleviate this technical challenge by enabling consistent data operation patterns across different schemas for one or more data operation types.

In some examples, a tenant can interact with their data in a shared schema as if it were stored in a standalone schema, while benefiting from resource efficiency of the shared schema model. For at least some data operations, the system may provide a consistent structure or syntax across both schema types in the multi-tenant system. For example, the same Structured Query Language (SQL) statements can be used for querying, updating, and deleting data, regardless of whether the data is stored in a standalone schema or accessed through a virtual schema in a shared schema environment. This uniformity can simplify application development and maintenance by allowing developers to use consistent code patterns across different tenant configurations.

When the effects in this disclosure are considered in aggregate, one or more of the systems or methodologies described herein may obviate a need for certain efforts or resources that otherwise would be involved in data storage or storage schema management. Computing resources utilized by systems, databases, or networks may be more efficiently utilized or reduced, e.g., as a result of a reduction in the overall storage space or computing resources needed to provide and maintain a multi-tenant system. Examples of such computing resources may include data storage capacity, memory usage, processor cycles, network traffic, power consumption, or cooling capacity.

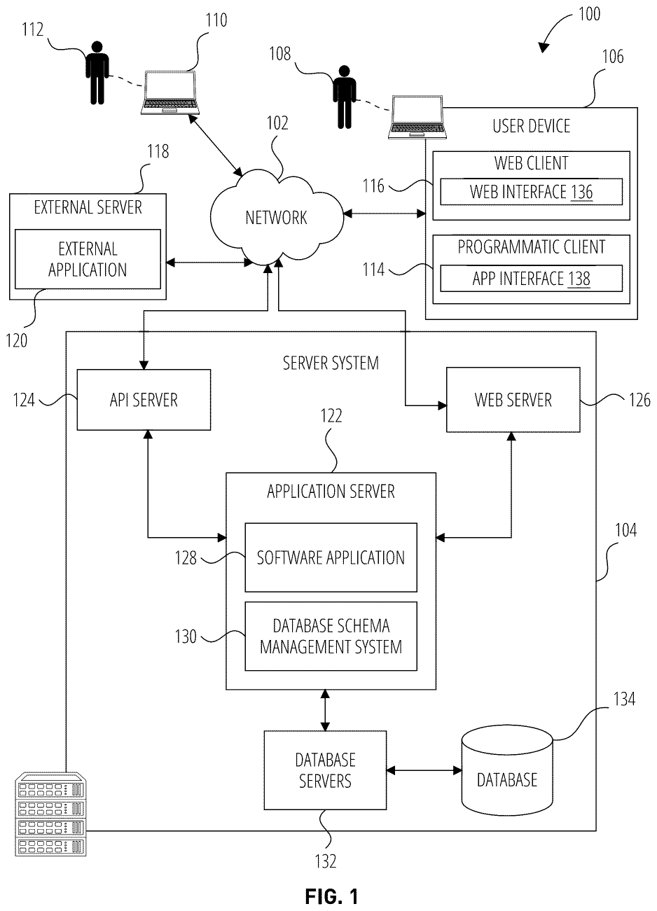

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a user 108. A web client 116 (e.g., a browser) or a programmatic client 114 (e.g., an “app”) may be hosted and executed on the user device 106.

An Application Program Interface (API) server 124 and a web server 126 provide respective programmatic and web interfaces to components of the server system 104. An application server 122 hosts a software application 128 and a database schema management system 130, each of which includes components or modules. It is noted that the software application 128 and the database schema management system 130 can be hosted by the same application server or across multiple servers.

The user device 106 can communicate with the application server 122, for example, via the web interface supported by the web server 126 or via the programmatic interface provided by the API server 124. The network environment can include multiple user devices. For example, FIG. 1 further shows a user device 110 of a user 112, which may be similar to the user device 106. For instance, the user device 106 is associated with a first tenant of a multi-tenant system and the user device 110 is associated with a second tenant of the multi-tenant system.

It will be appreciated that, although only two user devices are shown in FIG. 1, a larger number of user devices may be communicatively coupled to the server system 104 in some examples. For example, a multi-tenant system may have a large number of tenants, with each tenant being associated with one or more user devices or user accounts that access the server system 104. For ease of reference, the user device 106 is primarily referenced in the descriptions of examples below. Further, while certain functions may be described herein as being performed at either a user device (e.g., web client 116 or programmatic client 114) or the server system 104, the location of certain functionality either within the user device or the server system 104 may be a design choice.

The application server 122 is communicatively coupled to database servers 132, facilitating access to one or more information storage repositories, such as a database 134. In some examples, the database 134 includes storage devices that store information to be processed by the software application 128.

The application server 122 accesses application data (e.g., application data stored by the database servers 132) to provide one or more applications or software tools to the user device 106 via a web interface 136 or an app interface 138. For example, the application server 122 provides the user device 106 with access to the software application 128 and access to the database schema management system 130.

The software application 128 can, for example, be an enterprise resource planning (ERP) or business management application offered by way of a SaaS model. The software application 128 can include different modules, such as finance, supply chain, manufacturing, human resources, procurement, or customer relationship management. However, the aforementioned types of applications or modules are merely examples, and the software application 128 can be another type of application in other examples.

The software application 128 may interact with the database schema management system 130 to store and retrieve data related to multiple tenants using the software application 128. In some examples, the database schema management system 130 includes components for creating and managing tenants, and creating and managing different schema types, such as standalone schemas and shared schemas. The database schema management system 130 can include components for generating virtual schemas, implementing operation patterns for operating on data (e.g., stored in the database 134), and facilitating schema type conversions. The software application 128 or the database schema management system 130 may include user interface components that allow tenants to select their preferred schema type, manage their data storage model, or change their data storage model.

In some examples, the database schema management system 130 further includes optimization features to efficiently manage resources across different schema types. This may involve balancing the allocation of hardware and software resources between tenants using standalone schemas and those using shared schemas. In some examples, aspects or features of the database schema management system 130 are implemented on or via the database servers 132.

In some examples, the application server 122 is part of a cloud-based platform provided by a software provider (e.g., SaaS provider) that allows the user 108 to utilize the tools of the software application 128 and benefit from data storage schema options managed by the database schema management system 130. For example, the user 108 can be an account holder who uses suitable credentials to access the software application 128 and manage data storage options for the tenant associated with that account.

In some examples, a multi-tenant environment is provided by the server system 104, allowing multiple tenants to coexist within the same system while offering flexibility in data storage options. For instance, the software application 128 and database schema management system 130 work together to implement this multi-tenant architecture. The user 108 may be associated with a particular tenant, and thus has access to the data (e.g., in the database 134) for that particular tenant, while the user 108 is not provided with access to data associated with other tenants.

Tenants can choose between standalone schemas for enhanced data isolation and security, or shared schemas for improved resource efficiency. The server system 104 may create virtual schemas with views for tenants using the shared schema, allowing them to interact with their data as if it were in a standalone schema. This approach enables the server system 104 to efficiently support a large number of tenants with varying data storage requirements. The ability to convert between schema types further enhances the multi-tenant capabilities, allowing tenants to adapt their data storage model as their needs change over time.

This flexible, hybrid approach may allow a SaaS provider to cater to diverse tenant requirements within a single, unified system, effectively creating a scalable and efficient multi-tenant environment.

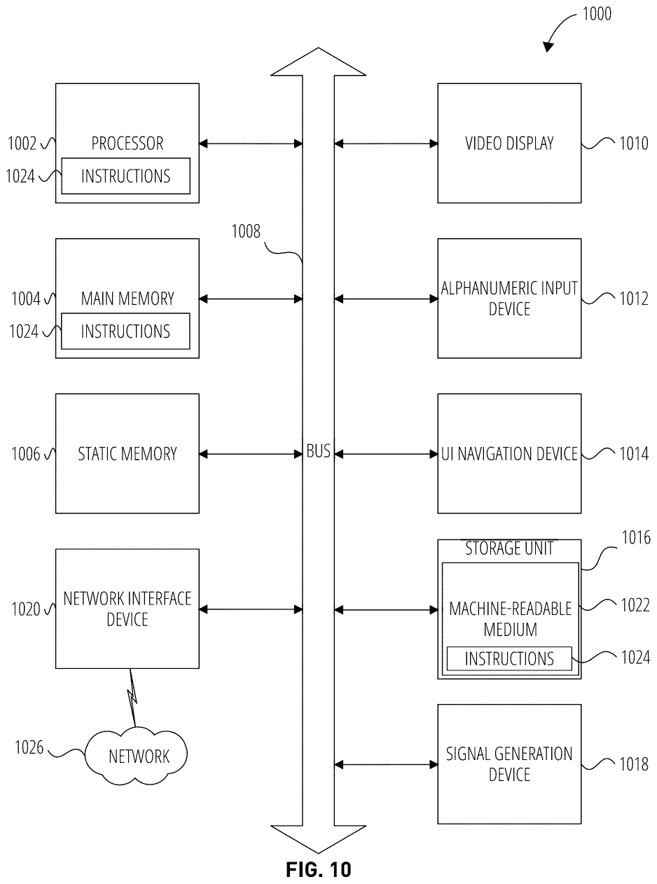

One or more of the application server 122, the database servers 132, the API server 124, or the web server 126 may each be implemented in a computer system, in whole or in part, as described below with respect to FIG. 10. In some examples, external applications, such as an external application 120 executing on an external server 118, can communicate with the application server 122 via the programmatic interface provided by the API server 124. For example, a third-party application may support one or more features or functions on a website or platform hosted by a third party, or may perform certain methodologies and provide input or output information to the application server 122 for further processing or publication.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

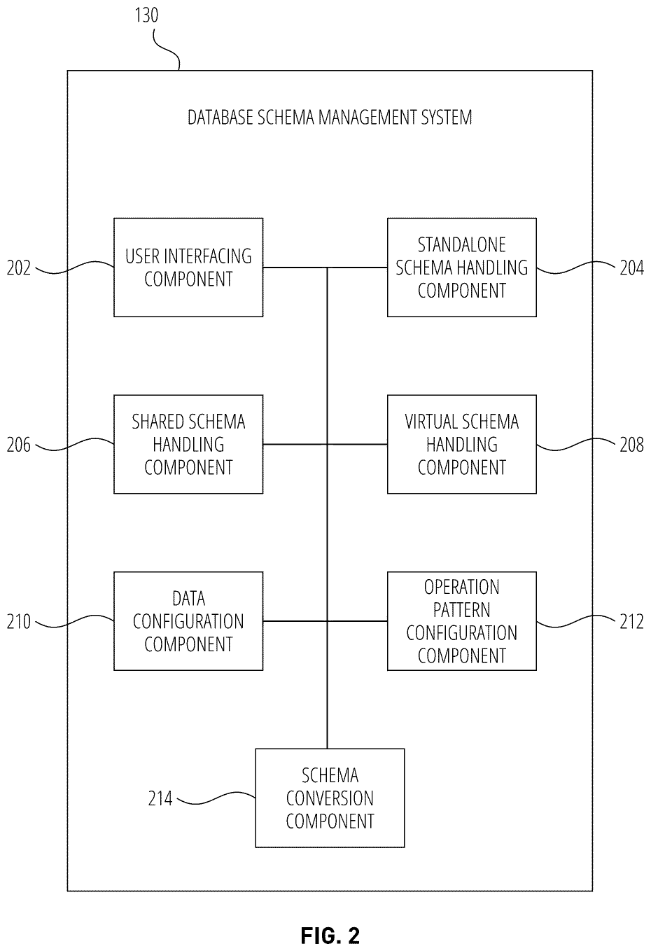

FIG. 2 illustrates components of the database schema management system 130 of FIG. 1, according to some examples. The database schema management system 130 is shown to include a user interfacing component 202, a standalone schema handling component 204, a shared schema handling component 206, a virtual schema handling component 208, a data configuration component 210, an operation pattern configuration component 212, and a schema conversion component 214.

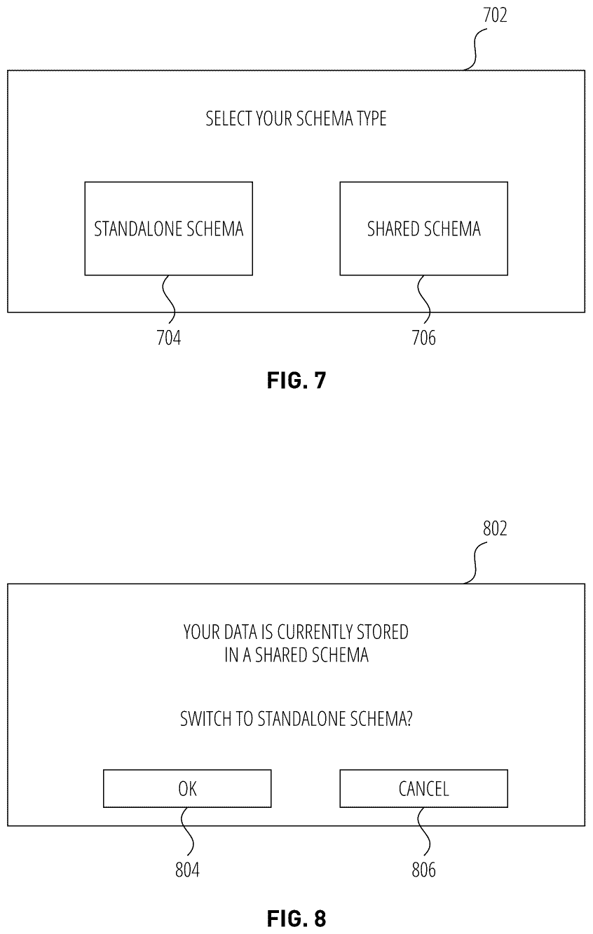

The user interfacing component 202 is responsible for interacting with tenants and handling schema-related requests. In some examples, the user interfacing component 202 provides user interfaces that allow tenants to select their preferred schema type (e.g., standalone or shared), manage schema settings or options, or initiate schema type conversions. FIG. 7 and FIG. 8, which are described below, show examples of user interfaces.

The standalone schema handling component 204 includes functionality for creating and managing standalone schemas within the database schema management system 130. In some examples, the standalone schema handling component 204 is responsible for generating and maintaining dedicated schemas with individual tables for tenants who choose the standalone option. The standalone schema handling component 204 can handle tasks such as creating new tables, managing data storage, and ensuring data isolation for each tenant using a standalone schema.

The shared schema handling component 206 is responsible for creating and managing a shared schema used by multiple tenants. In some examples, the shared schema handling component 206 is responsible for maintaining a common schema with shared tables, distinguishing data by tenant identifiers. The shared schema handling component 206 may handle tasks such as inserting data with appropriate tenant identifiers, managing shared resources, or optimizing performance for multi-tenant data storage. The shared schema handling component 206 can also be responsible for ensuring a logical separation between tenant data such that one tenant cannot gain access to, or manipulate, another tenant's data within the same shared schema.

The virtual schema handling component 208 includes functionality for creating and managing virtual schemas. In some examples, the virtual schema handling component 208 generates, for each tenant that opts for the shared schema, views that correspond to shared tables and filter data based on the relevant tenant identifier.

The virtual schema handling component 208 can create and store view definitions, allowing tenants to access and operate on their data in the shared schema. Accordingly, data in the shared schema can be accessed or operated on via a virtual schema as described in the present disclosure. The schema is referred to as “virtual” since it does not contain, for example, actual tables with data, but rather provides views that enable tenants to operate on shared schema data. In some examples, the virtual schema handling component 208 is responsible for dynamically updating views as tenants switch between schema types or as an underlying shared schema changes.

The data configuration component 210 is configured for managing an overall data structure and organization within the database 134. In some examples, the data configuration component 210 handles tasks such as defining table structures, managing data types, and ensuring data integrity across different schema types.

In some examples, the data configuration component 210 manages a global table (or other global data structure) that holds schema identifier and a schema type identifier for each tenant. Table 1 below is a simplified example that illustrates part of such a global table.

TABLE 1
Example of part of a global table

| TENANT_ID | SCHEMA | SCHEMA_TYPE |
|---|---|---|
| TENANT_1 | SCHEMA_1 | standalone |
| TENANT_2 | SCHEMA_2 | shared |
| . . . | . . . | . . . |

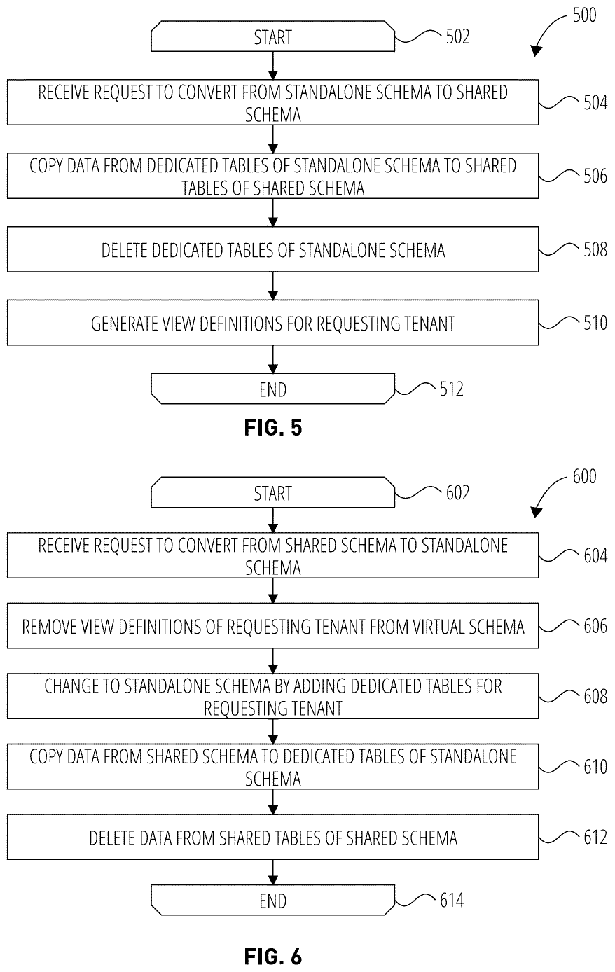

When operating on tenant data, a database system may first query the global table to determine the schema and schema type of the relevant tenant, and then perform operations based on the schema type (e.g., use preconfigured operation patterns for that schema type). During operations, mappings in the global table may be added to cache memory to speed up this process. Furthermore, in some examples, when the schema type of a tenant is changed by the database schema management system 130 (e.g., as described with reference to FIG. 5 or FIG. 6), the database schema management system 130 automatically updates schema type for the tenant (e.g., the relevant entry in the “SCHEMA_TYPE” column).

The operation pattern configuration component 212 implements and manages preconfigured operation patterns for operating on data in the database 134. In some examples, the operation pattern configuration component 212 implements uniform operation patterns across different schema types. The operation pattern configuration component 212 can be configured to ensure that certain data operations (such as querying, updating, and deleting) use consistent statement structures (e.g., SQL statement structures) regardless of whether the data is stored in a standalone schema or accessed through a virtual schema in a shared environment. In some examples, one or more operation types (such as inserting) do not use uniform operation patterns, and instead different between the shared schema and the standalone schema, as described in greater detail elsewhere in the present disclosure.

The schema conversion component 214 handles conversions between different schema types. In some examples, the database schema management system 130 allows tenants to switch between schema types, with the schema conversion component 214 being configured to manage the process of converting a tenant's data from a standalone schema to a shared schema, or vice versa. The schema conversion component 214 can handle tasks such as data migration, schema structure modification, and view creation or deletion during the conversion process. The schema conversion component 214 can communicate with the data configuration component 210, for example, to dynamically update the global table to reflect schema type adjustments.

In some examples, at least some of the components shown in FIG. 2 are configured to communicate with each other to implement aspects described herein. One or more of the components described herein may be implemented using hardware (e.g., one or more processors of one or more machines) or a combination of hardware and software. For example, a component described herein may be implemented by a processor configured to perform the operations described herein for that component. Moreover, two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

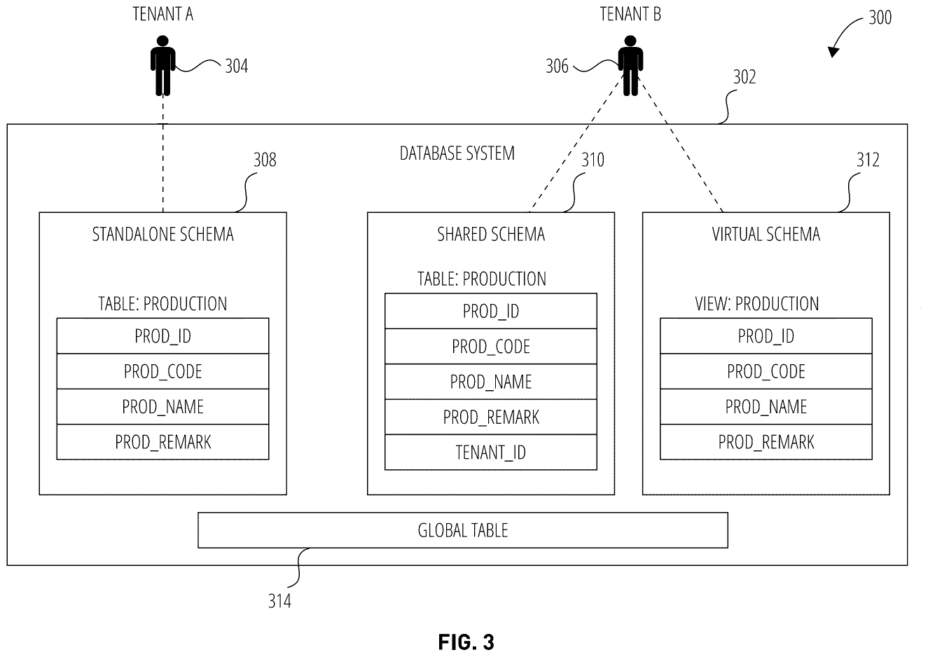

FIG. 3 shows a diagram 300 of a hybrid data storage architecture, according to some examples. The hybrid data storage architecture is provided within a database system 302 which can, for instance, be implemented using the server system 104 of FIG. 1 and the database schema management system 130 of FIG. 2.

Two tenants are depicted in FIG. 3: tenant A 304 and tenant B 306. The tenants are part of a multi-tenant system for which the hybrid data storage architecture is provided. In this example, tenant A has opted for a standalone schema 308 and tenant B has opted for a shared schema 310, and the database system 302 is configured to permit both schemas to exist and operate within the same database environment.

The standalone schema 308 contains dedicated tables for tenant A, including a table named “PRODUCTION” with the following columns: “PROD_ID,” “PROD_CODE,” “PROD_NAME,” and “PROD_REMARK.” The database system 302 thus provides a separate and isolated data structure for tenant A. It is noted that while only a single table is shown in the standalone schema 308 of FIG. 3, the table is shown for illustrative purposes and the standalone schema 308 may include multiple different tables, all dedicated to data of tenant A.

The shared schema 310 includes shared tables for multiple other tenants, including tenant B (for ease of reference, only tenant B is shown in FIG. 3). The shared tables of the shared schema 310 include a table named “PRODUCTION,” with the same columns as the “PRODUCTION” table of the standalone schema 308. However, the table in the shared schema 310 further includes a “TENANT_ID” column to distinguish between different tenants. Again, it is noted that while only a single table is shown in the shared schema 310 of FIG. 3, the table is shown for illustrative purposes and the shared schema 310 may include multiple different tables, each storing data of multiple tenants.

Furthermore, a virtual schema 312 is generated for tenant B. The virtual schema 312 is associated with the shared schema and includes view definitions corresponding the shared tables utilized by tenant B. For example, and as shown in FIG. 3, the virtual schema 312 defines a view named “PRODUCTION” that filters the data from the shared PRODUCTION table in the shared schema 310 based on the tenant identifier of tenant B, thus presenting only the relevant data (“PROD_ID,” “PROD_CODE,” “PROD NAME,” “PROD_REMARK”) for tenant B and maintaining data separation within the shared structure.

In some examples, the virtual schema 312 is “virtual” in the sense that it stores no real tables (e.g., only view definitions and, in some cases, other metadata). Each view defined by the virtual schema 312 may match a name of a corresponding table in the shared schema 310. A corresponding table can also exist in the standalone schema 308, where the same table structure is used across the different schema types. For example, and as shown in FIG. 3, the standalone schema 308 includes a table “PRODUCTION,” the shared schema 310 includes a table “PRODUCTION,” and the virtual schema 312 defines a view “PRODUCTION” used to operate on the “PRODUCTION” table of the shared schema 310.

A separate virtual schema and/or separate views can be generated for each tenant. In some examples, in use, when a query is executed against the view with respect to a particular tenant, the database system 302 uses the stored view definition to retrieve the relevant data of the tenant from the underlying shared schema (e.g., from shared schema 310). This approach allows for efficient storage in a shared manner while still providing the appearance of a separate schema for each tenant in the shared model.

In some examples, and as shown in FIG. 3, the database system 302 also maintains a global table 314 that identifies the schema and schema type of each tenant. The global table 314 may be similar to the example global table discussed with reference to Table 1.

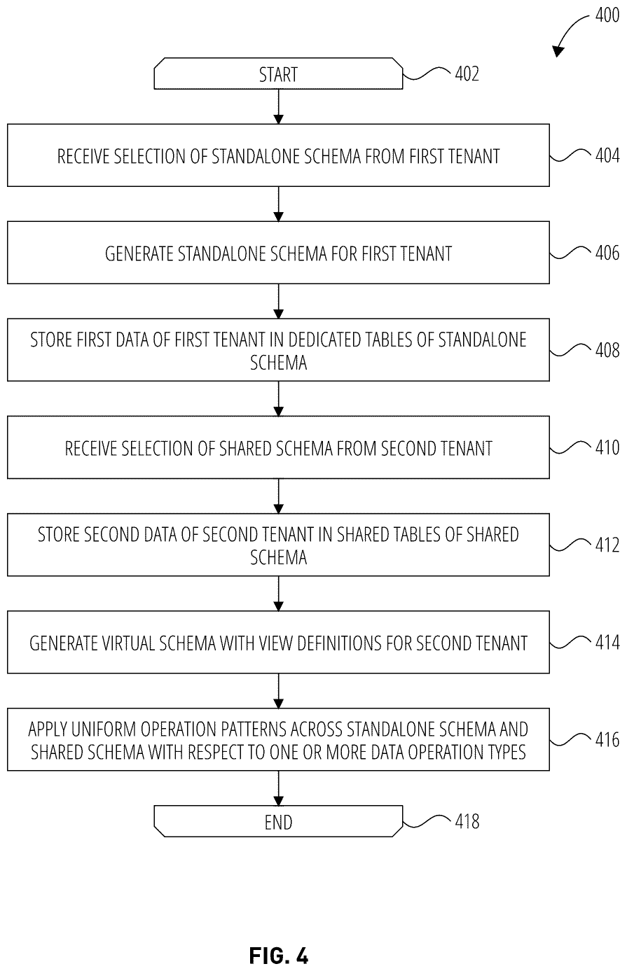

FIG. 4 is a flowchart illustrating operations of a method 400 for providing hybrid data storage in a multi-tenant environment, according to some examples. By way of example and not limitation, aspects of the method 400 may be performed by the components, devices, systems, or databases shown in FIG. 1 to FIG. 3. Accordingly, some of these components, devices, systems, or databases may be referenced in the description below.

The method 400 commences at opening loop operation 402 and proceeds to operation 404, where the database schema management system 130 receives, from a first tenant, a selection of a standalone schema (e.g., via the user interfacing component 202). For example, tenant A 304 in FIG. 3 makes a selection, via the user device 106 of FIG. 1, to have data stored and managed using a standalone schema data storage model. In response to this selection, at operation 406, the database schema management system 130 generates a standalone schema for the first tenant (e.g., the standalone schema 308 is generated by the standalone schema handling component 204 for tenant A). The first tenant has first data, which are stored in dedicated tables in accordance with the standalone schema (operation 408).

At operation 410, the database schema management system 130 receives, from a second tenant, a selection of a shared schema. For example, tenant B 306 of FIG. 3 makes a selection, via the user device 110 of FIG. 2, to have data stored and managed using the shared schema data storage model. In response to this selection, at operation 412, the database schema management system 130 stores second data of the second tenant in shared tables of the shared schema (e.g., the shared schema 310 of FIG. 3 is used by the shared schema handling component 206 of FIG. 2).

Furthermore, in response to the selection in operation 410, the database schema management system 130 generates a virtual schema with one or more view definitions for the second tenant at operation 414 (e.g., using the virtual schema handling component 208). For example, the shared schema includes multiple shared tables in which the second data of the second tenant are stored, and the virtual schema is generated by the database schema management system 130 to define views that correspond to those shared tables and that filter based on a tenant identifier of the second tenant.

Accordingly, in some examples, the database schema management system 130 creates a new schema for the second data of the second tenant, but instead of creating corresponding real tables in the new schema, the database schema management system 130 creates views (e.g., imaginary tables) with the same names corresponding to the real tables in the existing shared schema. For example, and referring back to the example of FIG. 3, if the shared schema has a table “PRODUCTION,” the database schema management system 130 automatically generates a view definition for a “PRODUCTION” view, as follows, for the second tenant (“tenant2”):

CREATE VIEW SCHEMA2.PRODUCTION AS
SELECT PROD_ID, PROD_CODE, PROD_NAME, PROD_REMARK
FROM SCHEMA_SHARED.PRODUCTION
WHERE TENANT_ID = ‘tenant2’

In this way, the second tenant's data is still stored in the shared schema, and relatively little data is stored in the new schema (e.g., the virtual schema, indicated as “SCHEMA2” in the above statement example). For example, the new schema only stores view definitions, such as statements that define virtual tables, and does not store the underlying data. This storage model approach utilizes less hardware and/or software resources using standalone schemas exclusively. Where the shared schema covers multiple tenants, a respective virtual schema can be generated for each of those tenants in the manner described.

The second data in the shared schema can be operated on via the virtual schema. For example, when a query is executed against a view, the database schema management system 130 uses the relevant view definition to dynamically retrieve and filter data from the shared tables of the shared schema. In some examples, and as shown in the method 400 of FIG. 4, the database schema management system 130 applies uniform operation patterns across the standalone schema and the shared schema with respect to one or more data operation types (operation 416).

For example, when performing data operations on the first data in the standalone schema and the second data in the shared schema, uniform operation patterns are applied for querying (e.g., retrieval or selecting), editing (e.g., updating or modifying), and/or deleting (e.g., data removal) operations, respectively. This can include similar SQL statement structures that are preconfigured and automatically applied for both standalone and shared schema data operations. In some examples, the database system is preconfigured via the operation pattern configuration component 212 as described with reference to FIG. 2 such that these data operations are automatically run in response to requests (e.g., requests from the user device 106).

For instance, the database system can be configured to apply uniform operation patterns for querying, editing, and deleting operations, as follows. In an example scenario where the first tenant owns a table “SCHEMA1.PRODUCTION” in a standalone schema, and the second tenant owns a view “SCHEMA2.PRODUCTION” that is associated with the shared schema, the same pattern of SQL clauses can be used to “SELECT” data for the first tenant and the second tenant as follows.
To query PRODUCTION by PROD_CODE for the first tenant that has a standalone schema, the database system uses:

SELECT PROD_ID, PROD_CODE, PROD_NAME, PROD_REMARK
FROM SCHEMA1.PRODUCTION
WHERE PROD_CODE = ?

To query PRODUCTION by PROD_CODE for the second tenant that uses the shared schema, the database system uses:

SELECT PROD_ID, PROD_CODE, PROD_NAME, PROD_REMARK
FROM SCHEMA2.PRODUCTION
WHERE PROD_CODE = ?

It will be noted from the above example that the “SELECT” statements used for standalone schema data and shared schema data have the same structures (the only difference, from a content perspective, is the schema name). Similar patterns can also be applied to “UPDATE” and “DELETE” data for both the first tenant and the second tenant, as shown below:

To update PRODUCTION by PROD_CODE for the first tenant that has the standalone schema, the database system uses:

UPDATE SCHEMA1.PRODUCTION
SET PROD_NAME = ?, PROD_REMARK = ?
WHERE PROD_CODE = ?

To update PRODUCTION by PROD_CODE for the second tenant that uses the shared schema, the database system uses:

UPDATE SCHEMA2.PRODUCTION
SET PROD_NAME = ?, PROD_REMARK = ?
WHERE PROD_CODE = ?

To delete from PRODUCTION by PROD_CODE for the first tenant that has the standalone schema, the database system uses:

DELETE FROM SCHEMA1.PRODUCTION
WHERE PROD_CODE = ?

To delete from PRODUCTION by PROD_CODE for the second tenant that uses the shared schema, the database system uses:

DELETE FROM SCHEMA2.PRODUCTION
WHERE PROD_CODE = ?

As with the SELECT statements, these UPDATE and DELETE statements maintain the same structure for both standalone and shared schemas, with the only difference at implementation time being the schema name. Accordingly, preconfigured operations patterns can be uniform for at least one of querying operations, editing operations, and deleting operations. This provides one or more technical benefits. For example, when developing a multi-tenant SaaS system that provides a hybrid data storage architecture, developers need not generate different SQL clause structures or templates for standalone schemas and shared schemas for at least some types of data operations. This can save time and ensure that computing resources are more efficiently utilized.

It is noted that operations patterns may, however, be nonuniform for some types of data operations. For example, operation patterns for inserting operations are nonuniform between the standalone schema and the shared schema, as indicated below (where the above example is continued):
To create records through the INSERT clause for the first tenant that has the standalone schema, the database system uses:

INSERT INTO SCHEMA1.PRODUCTION (PROD_ID, PROD_CODE,
PROD_NAME, PROD_REMARK)
VALUES (?, ?, ?, ?)

To create records through the INSERT clause for the second tenant that uses the shared schema, the database system uses:

INSERT INTO SCHEMA_SHARED. PRODUCTION (PROD_ID, PROD_CODE,
PROD_NAME, PROD_REMARK, TENANT_ID)
VALUES (?, ?, ?, ?, ‘tenant2’)

However, in many systems, “SELECT” and “UPDATE” constitute the most complex statements, which means that significant efficiency gains can be achieved even where clause discrepancies exist for “INSERT” operations. The method 400 ends at closing loop operation 418.

In addition to the automated generation of hybrid schema configurations, examples in the present disclosure enable automated schema type conversions. For example, a tenant might initially use the database schema management system 130 to select a standalone schema model for their data, and then later decide that a shared schema model is desired. The database schema management system 130 is configured, in response to a request, to automatically transform the tenant's data storage model from one schema type to another within a multi-tenant system context. The conversion process may involve several sub-processes, including, for example, data migration, schema structure modification, and view creation or deletion, as described in greater detail below with reference to FIG. 5 and FIG. 6.

FIG. 5 is a flowchart illustrating operations of a method 500 for automatically converting a schema type from a standalone schema to a shared schema, according to some examples. By way of example and not limitation, aspects of the method 500 may be performed by the components, devices, systems, or databases shown in FIG. 1 to FIG. 3. Accordingly, some of these components, devices, systems, or databases may be referenced in the description below.

The method 500 starts at opening loop operation 502 and proceeds to operation 504, where the database schema management system 130 receives a request to convert from a standalone schema to a shared schema. For example, tenant A 304 of FIG. 3 uses the user device 106 to access the database schema management system 130 and requests a schema type conversion. In response to receiving this request, the database schema management system 130 (e.g., using the schema conversion component 214) copies the data of the relevant tenant from the dedicated tables of their (current) standalone schema to the shared tables of the shared schema (operation 506). Continuing with the above examples related to FIG. 3 and the “PRODUCTION” table, an example of a SQL statement for initiating the copying process for the table “PRODUCTION” is shown below.

INSERT INTO SCHEMA_SHARED.PRODUCTION (PROD_ID, PROD_CODE,
PROD_NAME, PROD_REMARK, TENANT_ID)
SELECT PROD_ID, PROD_CODE, PROD_NAME, PROD_REMARK, ‘tenant1’
as TENANT_ID
FROM SCHEMA1.PRODUCTION

At operation 508, the database schema management system 130 deletes, from the standalone schema, the dedicated tables from which the data were copied in operation 506. An example of a SQL statement for initiating this process for the table “PRODUCTION” is shown below.
DROP TABLE SCHEMA1.PRODUCTION

At operation 510, the database schema management system 130 generates suitable views for the requesting tenant. For example, the database schema management system 130 generates a virtual schema with view definitions for the specific tenant. The views correspond to the shared tables into which the tenant's data were copied, and filter based on the tenant identifier of the tenant. In the schema type conversion context, the “generation” of the virtual schema can refer to the changing of the original standalone schema of the tenant to a virtual schema by (a) deleting the dedicated tables from it and (b) adding views (e.g., storing view definitions in it). Thus, the database schema management system 130 may generate the virtual schema for the tenant through the conversion of its existing schema (e.g., as identified in a global table) in the manner described.

An example of a SQL statement for initiating this process for the view “PRODUCTION” is shown below.

CREATE VIEW SCHEMA1.PRODUCTION AS
SELECT PROD_ID, PROD_CODE, PROD_NAME, PROD_REMARK
FROM SCHEMA_SHARED.PRODUCTION
WHERE TENANT_ID = ‘tenant1’

Once the operations 506, 508, and 510 have been completed by the database schema management system 130, the tenant's conversion to the shared schema is complete. In some examples, to complete the process, the database schema management system 130 also updates the global table (e.g., the global table 314) to reflect the change in schema type. For example, the global table is updated such that the same schema identifier (e.g., schema name) is shown for the relevant tenant, but to indicate that its type has changed from standalone to shared. The method 500 concludes at closing loop operation 512.

FIG. 6 is a flowchart illustrating operations of a method 600 for automatically converting a schema type from a shared schema to a standalone schema, according to some examples. By way of example and not limitation, aspects of the method 600 may be performed by the components, devices, systems, or databases shown in FIG. 1 to FIG. 3. Accordingly, some of these components, devices, systems, or databases may be referenced in the description below.

The method 600 starts at opening loop operation 602 and proceeds to operation 604, where the database schema management system 130 receives a request to convert from a shared schema to a standalone schema. For example, tenant B 306 of FIG. 3 uses the user device 110 to access the database schema management system 130 and requests a schema type conversion. In response to receiving this request, the database schema management system 130 (e.g., using the schema conversion component 214) removes the views related to the requesting tenant at operation 606. For example, the database schema management system 130 automatically removes the view definitions associated with the tenant from the virtual schema 312 of FIG. 3. Continuing with the above examples related to FIG. 3 and the “PRODUCTION” table, an example of a SQL statement for initiating dropping of the view for the “PRODUCTION” table is shown below.
DROP VIEW SCHEMA2.PRODUCTION

At operation 608, the database schema management system 130 changes the schema of the relevant tenant to a standalone schema. This may typically include adding dedicated tables in the tenant's schema (which was formerly a virtual schema), corresponding to the tables in the shared schema in which the tenant's data are initially stored. For example, the database schema management system 130 creates a real table “SCHEMA2.PRODUCTION” (whereas previously this was accomplished via a view for this tenant).

At operation 610, the database schema management system 130 copies the data of the relevant tenant from the shared schema to the tenant's schema. Thus, the virtual schema 312 automatically becomes a standalone schema that has dedicated tables with the data of the relevant tenant. An example of a SQL statement for initiating this process for the table “PRODUCTION” is shown below.

INSERT INTO SCHEMA2.PRODUCTION (PROD_ID, PROD_CODE,
PROD_NAME, PROD_REMARK)
SELECT PROD_ID, PROD_CODE, PROD_NAME, PROD_REMARK FROM
SCHEMA_SHARED.PRODUCTION
WHERE TENANT_ID= ‘tenant2’

Thus, in the schema type conversion context, “generating a standalone schema for the tenant” can refer to the changing of the original virtual schema of the tenant to a standalone schema by (a) removing the view definitions from it and (b) adding dedicated tables for the tenant. The dedicated tables can be populated with the tenant's data that initially co-existed with other tenants' data in the shared schema. Then, at operation 612, the database schema management system 130 deletes the data of the relevant tenant from the shared schema. An example of a SQL statement for initiating this process for the table “PRODUCTION” is shown below.

DELETE FROM SCHEMA_SHARED.PRODUCTION WHERE TENANT_ID=
‘tenant2’

Once the operations 606, 608, 610, and 612 have been completed by the database schema management system 130, the tenant's conversion to the standalone schema is complete. In some examples, to complete the process, the database schema management system 130 also updates the global table (e.g., the global table 314) to reflect the change in schema type. For example, the global table is updated such that the same schema identifier (e.g., schema name) is shown for the relevant tenant, but to indicate that its type has changed from shared to standalone. The method 600 concludes at closing loop operation 614.

FIG. 7 is a user interface diagram illustrating a user interface 702 that enables the selection of a standalone schema or a shared schema, according to some examples. The user interface 702 can be presented, for example, on the user device 106 of FIG. 1 (e.g., via the web interface 136). The user interface 702 enables a user (e.g., the user 108) associated with a tenant in a multi-tenant environment to select a standalone schema via a button 704 or a shared schema via a button 706. The buttons 704 and 706 are non-limiting examples and other user-selectable elements may be employed.

FIG. 8 is a user interface diagram illustrating a user interface 802 that enables the triggering of a conversion request for changing a schema type, according to some examples. The user interface 802 can be presented, for example, on the user device 106 of FIG. 1 (e.g., via the web interface 136). The user interface 802 enables a user (e.g., the user 108) associated with a tenant in a multi-tenant environment to switch from one schema type to another.

As shown in FIG. 8, the user can select a button 804 to switch from a shared schema to a standalone schema, or select a button 806 to cancel the process. User selection of the button 804 triggers the generation of a conversion request, which causes the database schema management system 130 to carry out an automated schema type conversion, as discussed elsewhere in the present disclosure. The buttons 804 and 806 are non-limiting examples and other user-selectable elements may be employed.

Examples described in the present disclosure provide a practical application that is specifically tied to computing technology. The technical solutions in the present disclosure can improve the functioning of computer systems, particularly in the context of a multi-tenant environment (e.g., a SaaS environment). The storage model and uniform operation patterns enabled by techniques in the present disclosure offer significant improvements in system efficiency, scalability, and/or resource utilization. By using consistent SQL (or other similar) statement structures for at least some data operations, regardless of the underlying schema type, the system can process instructions more efficiently and reduce the likelihood of errors.

For example, by allowing tenants to choose between standalone and shared schemas within the same database system, the described subject matter can improve resource allocation and overall system performance. This approach enables more efficient use of hardware and software resources, as it can support a large number of tenants using shared schemas while still accommodating tenants preferring dedicated resources. The ability to dynamically convert between schema types may further enhance system flexibility and efficiency, allowing for real-time or near real-time reconfiguration based on changing tenant needs.

The methodologies or features described herein cannot be accomplished except through the use of computing technologies due, for example, to the complex nature of generating, running, and managing multiple schema types simultaneously, the need for real-time data processing or filtering, and/or the need for dynamic schema conversions. Due to the scale of data in multi-tenant environments, and the need for rapid and consistent data operations across different schema types, computational resources that only computer systems can provide are leveraged, and the methodologies or features described herein thus cannot be practically accomplished by a human alone.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: generating a standalone schema comprising a plurality of dedicated tables for a first tenant; storing first data of the first tenant in the plurality of dedicated tables of the standalone schema; storing second data of a second tenant in a plurality of shared tables of a shared schema; generating a virtual schema comprising view definitions that correspond to the plurality of shared tables and that filter based on a tenant identifier of the second tenant; and performing data operations on the first data in the standalone schema and the second data in the shared schema, the second data in the shared schema being operated on via the virtual schema, and the data operations comprising one or more uniform operation patterns applied across the standalone schema and the shared schema.

In Example 2, the subject matter of Example 1 includes, wherein the tenant identifier is a second tenant identifier and the first tenant has a first tenant identifier, the operations further comprising: receiving, from a device associated with the first tenant, a conversion request: in response to receiving the conversion request, automatically performing a schema type conversion comprising: copying the first data from the standalone schema to at least a subset of the plurality of shared tables of the shared schema; deleting the plurality of dedicated tables of the standalone schema; and generating further view definitions that correspond to at least the subset of the plurality of shared tables and that filter based on the first tenant identifier of the first tenant.

In Example 3, the subject matter of any of Examples 1-2 includes, wherein the standalone schema is a first standalone schema for the first tenant, the operations further comprising: receiving, from a device associated with the second tenant, a conversion request: in response to receiving the conversion request, automatically performing a schema type conversion comprising: removing the view definitions from the virtual schema; generating a second standalone schema for the second tenant; copying the second data from the shared schema to the second standalone schema; and deleting the second data from the shared schema.

In Example 4, the subject matter of any of Examples 1-3 includes, wherein the one or more uniform operation patterns include one or more preconfigured operation patterns for at least one of querying operations, editing operations, or deleting operations.

In Example 5, the subject matter of Example 4 includes, wherein one or more operation patterns for inserting operations are nonuniform between the standalone schema and the shared schema.

In Example 6, the subject matter of any of Examples 1-5 includes, wherein the one or more uniform operation patterns comprise one or more Structured Query Language (SQL) statement structures that are automatically applied to data in both the standalone schema and the shared schema.

In Example 7, the subject matter of any of Examples 1-6 includes, wherein the one or more uniform operation patterns include preconfigured operation patterns for at least two of querying operations, editing operations, or deleting operations.

In Example 8, the subject matter of any of Examples 1-7 includes, wherein each of the view definitions define a view with a name that matches the name of a respective one of the plurality of shared tables.

In Example 9, the subject matter of any of Examples 1-8 includes, wherein the plurality of shared tables are shared among multiple tenants and distinguishes tenant data by respective tenant identifiers.

In Example 10, the subject matter of Example 9 includes, the operations further comprising: generating a respective virtual schema for each of the multiple tenants.

In Example 11, the subject matter of any of Examples 1-10 includes, the operations comprising: receiving, from a first device associated with the first tenant, a first selection to use the standalone schema, wherein the generating of the standalone schema is performed in response to the receiving of the first selection; and receiving, from a second device associated with the second tenant, a second selection to use the shared schema, wherein the generating of the virtual schema is performed in response to the receiving of the second selection.

In Example 12, the subject matter of Example 11 includes, the operations comprising: causing presentation of a user interface at the first device and the second device, the user interface including a first user-selectable element to perform the first selection and a second user-selectable element to perform the second selection.

In Example 13, the subject matter of any of Examples 2-12 includes, the operations comprising: causing presentation of a user interface at the device associated with the first tenant, the user interface including a user-selectable element to trigger generation of the conversion request.

In Example 14, the subject matter of any of Examples 3-13 includes, the operations comprising: causing presentation of a user interface at the device associated with the second tenant, the user interface including a user-selectable element to trigger generation of the conversion request.

Example 15 is a computer-implemented method performed by a computer system comprising a memory and at least one hardware processor, the computer-implemented method comprising: generating a standalone schema comprising a plurality of dedicated tables for a first tenant; storing first data of the first tenant in the plurality of dedicated tables of the standalone schema; storing second data of a second tenant in a plurality of shared tables of a shared schema; generating a virtual schema comprising view definitions that correspond to the plurality of shared tables and that filter based on a tenant identifier of the second tenant; and performing data operations on the first data in the standalone schema and the second data in the shared schema, the second data in the shared schema being operated on via the virtual schema, and the data operations comprising one or more uniform operation patterns applied across the standalone schema and the shared schema.

In Example 16, the subject matter of Example 15 includes, wherein the tenant identifier is a second tenant identifier and the first tenant has a first tenant identifier, the computer-implemented method further comprising: receiving, from a device associated with the first tenant, a conversion request: in response to receiving the conversion request, automatically performing a schema type conversion comprising: copying the first data from the standalone schema to at least a subset of the plurality of shared tables of the shared schema; deleting the plurality of dedicated tables of the standalone schema; and generating further view definitions that correspond to at least the subset of the plurality of shared tables and that filter based on the first tenant identifier of the first tenant.

In Example 17, the subject matter of any of Examples 15-16 includes, wherein the standalone schema is a first standalone schema for the first tenant, the computer-implemented method further comprising: receiving, from a device associated with the second tenant, a conversion request: in response to receiving the conversion request, automatically performing a schema type conversion comprising: removing the view definitions from the virtual schema; generating a second standalone schema for the second tenant; copying the second data from the shared schema to the second standalone schema; and deleting the second data from the shared schema.

Example 18 is one or more non-transitory computer-readable media storing computer-executable instructions that, when executed by a computing system, cause the computing system to perform operations comprising: generating a standalone schema comprising a plurality of dedicated tables for a first tenant; storing first data of the first tenant in the plurality of dedicated tables of the standalone schema; storing second data of a second tenant in a plurality of shared tables of a shared schema; generating a virtual schema comprising view definitions that correspond to the plurality of shared tables and that filter based on a tenant identifier of the second tenant; and performing data operations on the first data in the standalone schema and the second data in the shared schema, the second data in the shared schema being operated on via the virtual schema, and the data operations comprising one or more uniform operation patterns applied across the standalone schema and the shared schema.

In Example 19, the subject matter of Example 18 includes, wherein the tenant identifier is a second tenant identifier and the first tenant has a first tenant identifier, the operations further comprising: receiving, from a device associated with the first tenant, a conversion request: in response to receiving the conversion request, automatically performing a schema type conversion comprising: copying the first data from the standalone schema to at least a subset of the plurality of shared tables of the shared schema; deleting the plurality of dedicated tables of the standalone schema; and generating further view definitions that correspond to at least the subset of the plurality of shared tables and that filter based on the first tenant identifier of the first tenant.

In Example 20, the subject matter of any of Examples 18-19 includes, wherein the standalone schema is a first standalone schema for the first tenant, the operations further comprising: receiving, from a device associated with the second tenant, a conversion request: in response to receiving the conversion request, automatically performing a schema type conversion comprising: removing the view definitions from the virtual schema; generating a second standalone schema for the second tenant; copying the second data from the shared schema to the second standalone schema; and deleting the second data from the shared schema.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

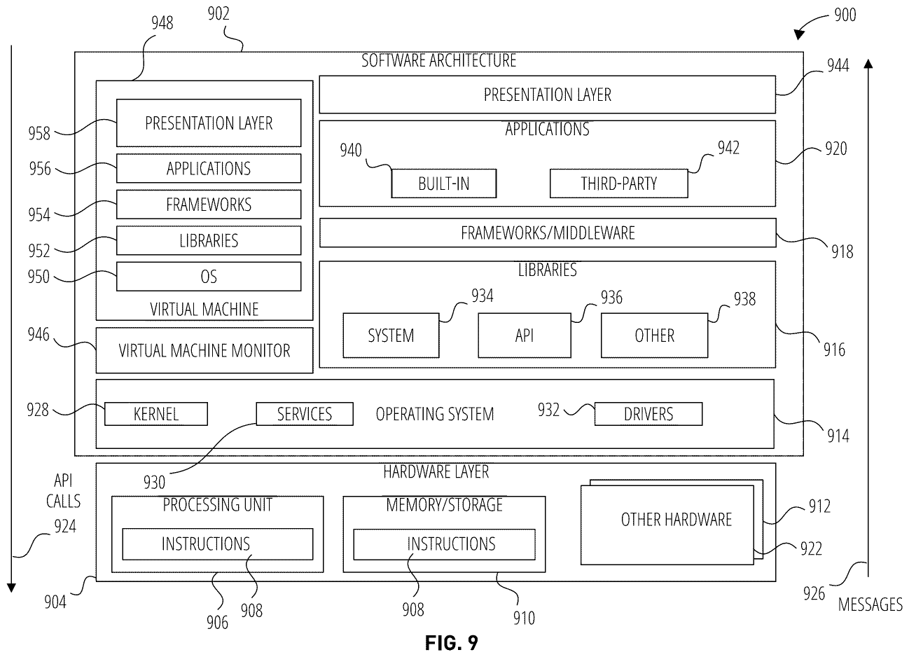

FIG. 9 is a block diagram 900 showing a software architecture 902 for a computing device, according to some examples. The software architecture 902 may be used in conjunction with various hardware architectures, for example, as described herein. FIG. 9 is merely a non-limiting illustration of a software architecture, and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 10.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 and other hardware 922 which represent any other hardware of the hardware layer 904, such as the other hardware illustrated as part of the software architecture 902.

In the architecture of FIG. 9, the software architecture 902 may be conceptualized as a stack of layers where each layer provides particular functionality. For example, the software architecture 902 may include layers such as an operating system 914, libraries 916, frameworks/middleware layer 918, applications 920, and presentation layer 944. Operationally, the applications 920 or other components within the layers may invoke API calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 916 may provide a common infrastructure that may be utilized by the applications 920 or other components or layers. The libraries 916 typically provide functionality that allows other software modules to perform tasks in an easier fashion than to interface directly with the underlying operating system 914 functionality (e.g., kernel 928, services 930 or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware layer 918 may provide a higher-level common infrastructure that may be utilized by the applications 920 or other software components/modules. For example, the frameworks/middleware layer 918 may provide various graphic user interface (GUI) functions, high-level resource management, high-level location services, and so forth. The frameworks/middleware layer 918 may provide a broad spectrum of other APIs that may be utilized by the applications 920 or other software components/modules, some of which may be specific to a particular operating system or platform.

The applications 920 include built-in applications 940 or third-party applications 942. Examples of representative built-in applications 940 may include, but are not limited to, a contacts application, a browser application, a book reader application, a location application, a media application, a messaging application, or a game application. Third-party applications 942 may include any of the built-in applications as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built in operating system functions (e.g., kernel 928, services 930 or drivers 932), libraries (e.g., system libraries 934, API libraries 936, and other libraries 938), and frameworks/middleware layer 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine as well as the interface with the host operating system (e.g., operating system 914). A software architecture executes within the virtual machine 948 such as an operating system 950, libraries 952, frameworks/middleware 954, applications 956 or presentation layer 958. These layers of software architecture executing within the virtual machine 948 can be the same as corresponding layers previously described or may be different.

Certain examples are described herein as including logic or a number of components, modules, or mechanisms. Modules or components may constitute either software modules/components (e.g., code embodied (1) on a non-transitory machine-readable medium or (2) in a transmission signal) or hardware-implemented modules/components. A hardware-implemented module/component is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module/component that operates to perform certain operations as described herein.

In various examples, a hardware-implemented module/component may be implemented mechanically or electronically. For example, a hardware-implemented module/component may comprise dedicated circuitry or logic that is permanently configured (e.g., as a special-purpose processor, such as a field programmable gate array (FPGA) or an application-specific integrated circuit (ASIC)) to perform certain operations. A hardware-implemented module/component may also comprise programmable logic or circuitry (e.g., as encompassed within a general-purpose processor or another programmable processor) that is temporarily configured by software to perform certain operations.

Accordingly, the term “hardware-implemented module” or “hardware-implemented component” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules/components are temporarily configured (e.g., programmed), each of the hardware-implemented modules/components need not be configured or instantiated at any one instance in time. For example, where the hardware-implemented modules/components comprise, a general-purpose processor configured using software, the general-purpose processor may be configured as respective different hardware-implemented modules/components at different times. Software may accordingly configure a processor, for example, to constitute a particular hardware-implemented module/component at one instance of time and to constitute a different hardware-implemented module/component at a different instance of time.

Hardware-implemented modules/components can provide information to, and receive information from, other hardware-implemented modules/components. Accordingly, the described hardware-implemented modules/components may be regarded as being communicatively coupled. Where multiple of such hardware-implemented modules/components exist contemporaneously, communications may be achieved through signal transmission (e.g., over appropriate circuits and buses that connect the hardware-implemented modules/components). In examples in which multiple hardware-implemented modules/components are configured or instantiated at different times, communications between such hardware-implemented modules/components may be achieved, for example, through the storage and retrieval of information in memory structures to which the multiple hardware-implemented modules/components have access. For example, one hardware-implemented module/component may perform an operation, and store the output of that operation in a memory device to which it is communicatively coupled. A further hardware-implemented module/component may then, at a later time, access the memory device to retrieve and process the stored output.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules/components that operate to perform one or more operations or functions. The modules/components referred to herein may, in some examples, comprise processor-implemented modules/components.

Similarly, the methods described herein may be at least partially processor-implemented. For example, at least some of the operations of a method may be performed by one or more processors or processor-implemented modules/components. The performance of certain of the operations may be distributed among the one or more processors, not only residing within a single machine, but deployed across a number of machines.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

FIG. 10 is a block diagram of a machine in the example form of a computer system 1000 within which instructions 1024 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a GPU, or both), a primary or main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a UI navigation (or cursor control) device 1014 (e.g., a mouse), a storage unit 1016, a signal generation device 1018 (e.g., a speaker), and a network interface device 1020.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware.

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 or within the processor 1002 during execution thereof by the computer system 1000, with the main memory 1004 and the processor 1002 also each constituting a machine-readable medium 1022.

While the machine-readable medium 1022 is shown in accordance with some examples to be a single medium, the term “machine-readable medium” may include a single medium or multiple media (e.g., a centralized or distributed database, or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of a machine-readable medium 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 1024 may further be transmitted or received over a communications network 1026 using a transmission medium. The instructions 1024 may be transmitted using the network interface device 1020 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any particular portions of this application. Where the context permits, words using the singular or plural number may also include the plural or singular number, respectively. Except as otherwise indicated, the word “or” in reference to a list of two or more items, covers all of the following interpretations of the word: any one of the items in the list, all of the items in the list, and any combination of the items in the list.

Although some examples, such as those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence. The term “operation” is used to refer to elements in the drawings of this disclosure for ease of reference and it will be appreciated that each “operation” may identify one or more operations, processes, actions, or steps, and may be performed by one or multiple components.

1. A system comprising:
at least one memory that stores instructions; and
one or more processors configured by the instructions to perform operations comprising:
generating a standalone schema comprising a plurality of dedicated tables for a first tenant;
storing first data of the first tenant in the plurality of dedicated tables of the standalone schema;
storing second data of a second tenant in a plurality of shared tables of a shared schema, the second data of the second tenant being distinguished from data of other tenants by use of a second tenant identifier of the second tenant;
storing third data of a third tenant in the plurality of shared tables of the shared schema, the third data of the third tenant being distinguished from data of other tenants by use of a third tenant identifier of the third tenant;
generating a virtual schema comprising view definitions that correspond to the plurality of shared tables and that filter based on the second tenant identifier; and
performing data operations on the first data in the standalone schema and the second data in the shared schema, the second data in the shared schema being operated on via the virtual schema, and the data operations comprising one or more uniform operation patterns applied across the standalone schema and the shared schema.

2. The system of claim 1, wherein the first tenant has a first tenant identifier, the operations further comprising:
receiving, from a device associated with the first tenant, a conversion request; and
in response to receiving the conversion request, automatically performing a schema type conversion to convert from the standalone schema to the shared schema, the schema type conversion comprising:
copying the first data from the standalone schema to at least a subset of the plurality of shared tables of the shared schema;
deleting the plurality of dedicated tables of the standalone schema; and
generating further view definitions that correspond to at least the subset of the plurality of shared tables and that filter based on the first tenant identifier of the first tenant.

3. The system of claim 1, wherein the standalone schema is a first standalone schema for the first tenant, the operations further comprising:
receiving, from a device associated with the second tenant, a conversion request; and
in response to receiving the conversion request, automatically performing a schema type conversion to convert from the shared schema to a further standalone schema, the schema type conversion comprising:
removing the view definitions from the virtual schema;
generating a second standalone schema for the second tenant;
copying the second data from the shared schema to the second standalone schema; and
deleting the second data from the shared schema.

4. The system of claim 1, wherein the one or more uniform operation patterns include one or more preconfigured operation patterns for at least one of querying operations, editing operations, or deleting operations.

5. The system of claim 4, wherein one or more operation patterns for inserting operations are nonuniform between the standalone schema and the shared schema.

6. The system of claim 1, wherein the one or more uniform operation patterns comprise one or more Structured Query Language (SQL) statement structures that are automatically applied to data in both the standalone schema and the shared schema.

7. The system of claim 1, wherein the one or more uniform operation patterns include preconfigured operation patterns for at least two of querying operations, editing operations, or deleting operations.

8. The system of claim 1, wherein each of the view definitions define a view with a name that matches the name of a respective one of the plurality of shared tables.

9. The system of claim 1, wherein the plurality of shared tables are shared among multiple tenants and distinguishes tenant data by respective tenant identifiers.

10. The system of claim 9, the operations further comprising:
generating a respective virtual schema for each of the multiple tenants.

11. The system of claim 1, the operations comprising:
receiving, from a first device associated with the first tenant, a first selection to use the standalone schema, wherein the generating of the standalone schema is performed in response to the receiving of the first selection; and
receiving, from a second device associated with the second tenant, a second selection to use the shared schema, wherein the generating of the virtual schema is performed in response to the receiving of the second selection.

12. The system of claim 11, the operations comprising:
causing presentation of a user interface at the first device and the second device, the user interface including a first user-selectable element to perform the first selection and a second user-selectable element to perform the second selection.

13. The system of claim 2, the operations comprising:
causing presentation of a user interface at the device associated with the first tenant, the user interface including a user-selectable element to trigger generation of the conversion request.

14. The system of claim 3, the operations comprising:
causing presentation of a user interface at the device associated with the second tenant, the user interface including a user-selectable element to trigger generation of the conversion request.

15. A computer-implemented method performed by a computer system comprising a memory and at least one hardware processor, the computer-implemented method comprising:
generating a standalone schema comprising a plurality of dedicated tables for a first tenant;
storing first data of the first tenant in the plurality of dedicated tables of the standalone schema;
storing second data of a second tenant in a plurality of shared tables of a shared schema, the second data of the second tenant being distinguished from data of other tenants by use of a second tenant identifier of the second tenant;
storing third data of a third tenant in the plurality of shared tables of the shared schema, the third data of the third tenant being distinguished from data of other tenants by use of a third tenant identifier of the third tenant;
generating a virtual schema comprising view definitions that correspond to the plurality of shared tables and that filter based on the second tenant identifier; and
performing data operations on the first data in the standalone schema and the second data in the shared schema, the second data in the shared schema being operated on via the virtual schema, and the data operations comprising one or more uniform operation patterns applied across the standalone schema and the shared schema.

16. The computer-implemented method of claim 15, wherein the first tenant has a first tenant identifier, the computer-implemented method further comprising:
receiving, from a device associated with the first tenant, a conversion request; and
in response to receiving the conversion request, automatically performing a schema type conversion to convert from the standalone schema to the shared schema, the schema type conversion comprising:
copying the first data from the standalone schema to at least a subset of the plurality of shared tables of the shared schema;
deleting the plurality of dedicated tables of the standalone schema; and
generating further view definitions that correspond to at least the subset of the plurality of shared tables and that filter based on the first tenant identifier of the first tenant.

17. The computer-implemented method of claim 15, wherein the standalone schema is a first standalone schema for the first tenant, the computer-implemented method further comprising:
receiving, from a device associated with the second tenant, a conversion request; and
in response to receiving the conversion request, automatically performing a schema type conversion to convert from the shared schema to a further standalone schema, the schema type conversion comprising:
removing the view definitions from the virtual schema;
generating a second standalone schema for the second tenant;
copying the second data from the shared schema to the second standalone schema; and
deleting the second data from the shared schema.

18. One or more non-transitory computer-readable media storing computer-executable instructions that, when executed by a computing system, cause the computing system to perform operations comprising:
generating a standalone schema comprising a plurality of dedicated tables for a first tenant;
storing first data of the first tenant in the plurality of dedicated tables of the standalone schema;
storing second data of a second tenant in a plurality of shared tables of a shared schema, the second data of the second tenant being distinguished from data of other tenants by use of a second tenant identifier of the second tenant;
storing third data of a third tenant in the plurality of shared tables of the shared schema, the third data of the third tenant being distinguished from data of other tenants by use of a third tenant identifier of the third tenant;
generating a virtual schema comprising view definitions that correspond to the plurality of shared tables and that filter based on a tenant identifier of the second tenant; and
performing data operations on the first data in the standalone schema and the second data in the shared schema, the second data in the shared schema being operated on via the virtual schema, and the data operations comprising one or more uniform operation patterns applied across the standalone schema and the shared schema.

19. The one or more non-transitory computer-readable media of claim 18, wherein the first tenant has a first tenant identifier, the operations further comprising:
receiving, from a device associated with the first tenant, a conversion request; and
in response to receiving the conversion request, automatically performing a schema type conversion to convert from the standalone schema to the shared schema, the schema type conversion comprising:
copying the first data from the standalone schema to at least a subset of the plurality of shared tables of the shared schema;
deleting the plurality of dedicated tables of the standalone schema; and
generating further view definitions that correspond to at least the subset of the plurality of shared tables and that filter based on the first tenant identifier of the first tenant.

20. The one or more non-transitory computer-readable media of claim 18, wherein the standalone schema is a first standalone schema for the first tenant, the operations further comprising:
receiving, from a device associated with the second tenant, a conversion request; and
in response to receiving the conversion request, automatically performing a schema type conversion to convert from the shared schema to a further standalone schema, the schema type conversion comprising:
removing the view definitions from the virtual schema;
generating a second standalone schema for the second tenant;
copying the second data from the shared schema to the second standalone schema; and
deleting the second data from the shared schema.
